(19) United States
(12) Patent Application Publication
(10) Pub. No.: US 2025/0380155 A1
(43) Pub. Date: Dec. 11, 2025

(54) System And Method For Enhanced Channel Configurations of Multiple Wireless Access Points (APs) in Dense Environments Using a Monte Carlo Algorithm

(71) Applicant: Charter Communications Operating, LLC, St. Louis, MO (US)

(72) Inventors: James M. KRUCZEK, Lone Tree, CO (US); Stewart T. VAN CLEAVE, Aurora, CO (US)

(21) Appl. No.: 18/734,812

(22) Filed: Jun. 5, 2024

(51) Int. Cl. H04W 24/02

(52) U.S. Cl. CPC H04W 24/02

(57) ABSTRACT

Systems, methods, and devices for methods for configuring multiple wireless access points (APs) in dense network environments, such as in multi-dwelling units (MDUs). The coordinator, which may be a central server or an elected leader, may be configured to manage multiple APs within a network for comprehensive performance improvements. The coordinator may compute the total quality score based on data from individual APs and determine whether to implement configuration changes, such as by changing configuration parameters for selection, channel width, and signal power.

### BACKGROUND

The proliferation of wireless networking technology has transformed modern communication systems, with wireless access points (APs) serving as vital components in facilitating seamless connectivity. In densely populated environments such as urban residential complexes, large office buildings, and educational institutions, the demand for robust and reliable wireless networks has intensified. These settings typically feature numerous APs in close proximity, leading to complex challenges related to signal overlap, channel interference, and network congestion. Effective management and optimization of wireless networks in such environments are important for maintaining high-quality user experiences and efficient use of available spectrum.

Network optimization techniques often involve selecting optimal channels, adjusting signal power, and configuring channel widths to minimize interference and enhance performance. Other methods for optimizing individual APs may inadvertently impact neighboring APs, creating a dynamic environment that requires repeated and ongoing reconfiguration. Accordingly, advanced wireless communication systems and network management solutions that enhance wireless network performance in dense environments may be highly desired by and beneficial to network service providers and consumers of their services.

### SUMMARY

Various aspects include methods of configuring multiple wireless access points (APs) in a dense network computing environment, the method which may include setting each of the multiple APs to an initial state (S0), measuring an initial quality score (Q0) for the initial state (S0) over a measurement period, defining and adjusting a measurement period to balance speed and accuracy of the results, and iteratively adjusting AP configurations by randomly selecting an AP from the multiple APs, making a random change to the configuration of the selected AP by adjusting a configuration parameter to transition from the initial state (S0) to a new state (S1), and measuring a new quality score (Q1) for the new state (S1) using the defined and adjusted measurement period.

Some aspects may further include evaluating configuration changes by comparing the new quality score (Q1) with the initial quality score (Q0), and accepting the new state (S1) as the new basis for subsequent configuration adjustments in response to determining that the new quality score (Q1) may be greater than the initial quality score (Q0).

Some aspects may further include applying probabilistic acceptance for suboptimal configurations by determining a probability of acceptance value for the new state (S1) in response to determining that the new quality score (Q1) may be not greater than the initial quality score (Q0), generating a random number between 0 and 1, and accepting the new state (S1) based on whether the random number may be less than the determined probability of acceptance value. In some aspects, determining the probability of acceptance value for the new state (S1) may include setting the probability of acceptance value equal to e^{(Q1-Q0)/T} in which T may be a tolerance parameter that may be indicative of the system tolerance for accepting suboptimal states.

Some aspects may further include repeatedly adjusting the AP configurations, evaluating the configuration changes, applying the probabilistic acceptance for the suboptimal configurations, and adjusting the tolerance parameter (T) over time to reduce the system tolerance for suboptimal states as the system approaches a threshold value indicating optimal configuration. In some aspects, the quality score may represent the quality of user experience associated with the wireless network facilitated by the multiple APs. In some aspects, the configuration parameters include at least one or more of a channel selection parameter, a channel width parameter, or a signal power parameter. In some aspects, making the random change to the configuration of the selected AP by adjusting the configuration parameter to transition from the initial state (S0) to the new state (S1) may include making a random change to the randomly selected configuration parameter of the selected AP to transition from the initial state (S0) to a new state (S1).

Further aspects may include a computing device having a processor configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause a processor to perform various operations corresponding to the method operations discussed above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1A is a block diagram of an example network suitable for implementing some embodiments.

FIG. 1B is a block diagram illustrating an example configuration of multiple wireless access points (APs) within a multi-dwelling unit (MDU) environment in accordance with some embodiments.

FIG. 2 is a process flow diagram illustrating a method of configuring multiple wireless access points (APs) in a dense network computing environment in accordance with some embodiments.

FIG. 3 is a block diagram illustrating an example evaluation of configurations in a grid-based system in accordance with some embodiments.

FIG. 4 is a process flow diagram illustrating another method of configuring multiple APs in a dense network computing environment in accordance with some embodiments.

FIG. 5 is process flow diagrams illustrating other methods of configuring multiple APs in a dense network computing environment in accordance with some embodiments.

FIG. 6 is a component diagram of an example server suitable for implementing the various embodiments.

### DETAILED DESCRIPTION

The various embodiments will be described in detail with reference to the accompanying drawings. The same reference numbers will be used throughout the drawings to refer to the same or like parts wherever possible. References to particular examples and implementations are for illustrative purposes and are not intended to limit the scope of the invention or the claims.

In overview, the various embodiments include methods and communication systems configured to implement the methods for configuring multiple wireless access points (APs) in dense network environments, such as in multi-dwelling units (MDUs). In some embodiments, the methods may include setting each AP to an initial state (S0), measuring an initial quality score (Q0) for the initial state (S0) that reflects the user experience quality, defining and adjusting the measurement period (e.g., to balance speed and accuracy, etc.), and iteratively adjusting AP configurations by randomly selecting an AP from the multiple APs operating in the dense network environment, making a random change to the selected AP's configuration (or to a selected configuration parameter, etc.) to transition it from its initial state (S0) to a new state (S1), measuring a new quality score (Q1) for S1 using the defined measurement period, comparing Q1 with Q0, and accepting the new state (S1) as the basis for further adjustments in response to determining that Q1 exceeds Q0.

In some embodiments, the methods may include applying probabilistic acceptance techniques for suboptimal configurations, such as by determining a probability of acceptance for S1 in response to determining that Q1 does not exceed Q0, generating a random number between 0 and 1, and accepting S1 in instance in which the random number is less than the determined probability. In some embodiments, the probability of acceptance may be calculated as e^{(Q1-Q0)/T}, where T is a tolerance parameter indicating the system's acceptance of suboptimal states.

The various embodiments may enhance the performance and functioning of the service provider network and the service provider network components by calibrating a collection of APs to consider collective network quality and functionality. Some embodiments may reduce channel interference, improve signal quality, and minimize network congestion by using a Monte Carlo-like algorithm for iterative configuration adjustments that result in a more stable and reliable wireless network that improves the user experience. In addition, the probabilistic acceptance of suboptimal configurations may allow the network to explore a wider range of potential configurations and facilitate the discovery of globally optimal settings. The dynamic adjustment of the tolerance parameter (T) may refine the optimization process and allow the system to adapt to real-time changes in network conditions. In addition, the embodiments may optimize or improve various configuration parameters, including channel selection, channel width, and signal power, reducing the need for manual intervention and improving overall network performance and reliability. The embodiments may allow for more effective spectrum use, reduce the need for manual intervention, and/or improve the overall performance and reliability of the network and its components. Further improvements to the performance and functioning of the service provider network and its components will be evident from the disclosures below.

The various embodiments may enhance the performance and functioning of the service provider network and its components by calibrating a collection of APs to consider collective network quality and functionality. Some embodiments may reduce channel interference, improve signal quality, and minimize network congestion by using a Monte Carlo-like algorithm for iterative configuration adjustments that result in a more stable and reliable wireless network. This may include the probabilistic acceptance of suboptimal configurations to allow the network to explore a wider range of potential configurations and facilitate the discovery of globally optimal settings. The dynamic adjustment of the tolerance parameter (T) may refine the optimization process and allow the system to adapt to real-time changes in network conditions. These embodiments may optimize various configuration parameters, including channel selection, channel width, and signal power, reducing the need for manual intervention and improving overall network performance and reliability.

The term “service provider network” may be used generically herein to refer to any network suitable for providing consumers with access to the Internet or IP services over broadband connections and may encompass both wired and wireless networks/technologies. Examples of wired network technologies and networks that may be included within a service provider network include active Ethernet networks, asymmetric digital subscriber line (ADSL) technologies, cable networks, data over cable service interface specification (DOCSIS) networks, enhanced ADSL (ADSL2+), Ethernet, fiber optic networks, fiber-to-the-x (FTTx) technologies, hybrid-fiber-cable (HFC) networks, local area networks (LAN), metropolitan area networks (MAN), passive optical networks (PON), satellite networks, wide area networks (WAN), 10 Gigabit Symmetrical Passive Optical Network (XGS-PON), etc. Examples of wireless network technologies and networks that may be included within a service provider network include third generation wireless mobile communication technology (3G), third generation partnership project (3GPP), 3GSM, fourth generation wireless mobile communication technology (4G), fifth generation wireless mobile communication technology (5G), sixth-generation wireless (6G), advanced mobile phone system (AMPS), Bluetooth®, CDMA systems (e.g., cdmaOne, CDMA2000), digital enhanced cordless telecommunications (DECT), digital AMPS (IS-136/TDMA), enhanced data rates for GSM evolution (EDGE), evolution-data optimized (EV-DO), general packet radio service (GPRS), global system for mobile communications (GSM), high-speed downlink packet access (HSDPA), integrated digital enhanced network (iDEN), land mobile radio (LMR), long term evolution (LTE) systems, low earth orbit (LEO) satellite internet technologies, massive multiple input multiple output (MIMO), millimeter-wave (mmWave) technologies for higher-speed wireless communication, new radio (NR), next-generation wireless systems (NGWS), universal mobile telecommunications system (UMTS), Wi-Fi 7 (802.11be), Wi-Fi Protected Access I & II (WPA, WPA2), wireless local area network (WLAN), worldwide interoperability for microwave access (WiMAX), etc. Each of these wired and wireless technologies discussed herein includes the transmission and reception of data, as well as the exchange of signaling and content messages. It should be understood that, while specific technologies and standards are described herein to exemplify the range of capabilities associated with a service provider network, these references and details are included to serve merely as illustrative examples. These references should not be construed as narrowing the scope of the claims to any particular communication system or technology unless specifically recited in the claim language.

The terms “computing device,” “user device,” and “user equipment” (UE) may be used interchangeably herein to refer to any of a wide variety of electronic devices capable of executing programmed instructions. These devices include smartphones, advanced cellular telephones, smart televisions, interactive voice-controlled assistants, contemporary digital video recorders (DVRs), smartwatches, residential and bridged gateways, laptops, tablets, satellite or cable set-top boxes (STBs), portable multimedia players, network-connected storage and gaming solutions, wearable fitness trackers, home automation interfaces, and other similar devices equipped with processors, memory, and/or integrated circuitry to facilitate the functionalities described herein. Modern computing devices typically support connectivity to various networks through modems, routers, and network switches, including advancements such as 5G-enabled smartphones and tablets, home IoT (Internet of Things) hubs, and ultra-high-definition streaming media devices.

The terms “component,” “module,” “system,” “engine,” and the like are used in this application to refer to various computer-related entities tasked with specific operational functions. These may include hardware components, software programs, combinations thereof, or processes in execution. For example, a component may be a software application executing on a device, a processor executing instructions, a thread of a program, or the device itself. Components may operate individually within a single processing environment or may be distributed across multiple processing units to utilize the capabilities of multicore or parallel computing architectures. Components may execute instructions stored on different types of non-transitory computer-readable media and communicate via local or remote process interactions, inter-process communications, electronic signaling, data packet transfers, and other established protocols for data exchange and function coordination.

The term “processing system” may be used herein to refer to one or more processors, including multi-core processors, that are organized and configured to perform various computing functions. Various embodiment methods may be implemented in one or more of multiple processors within a processing system as described herein.

The term “system on chip” (SoC) may be used herein to refer to a single integrated circuit (IC) chip that contains multiple resources or independent processors integrated on a single substrate. A single SoC may contain circuitry for digital, analog, mixed-signal, and radio-frequency functions. A single SoC may include a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices.

The term “system in a package” (SIP) may be used herein to refer to a single module or package that contains multiple resources, computational units, cores, or processors on two or more IC chips, substrates, or SoCs. For example, a SIP may include a single substrate on which multiple IC chips or semiconductor dies are stacked vertically. Similarly, the SIP may include one or more multi-chip modules (MCMs) on which multiple ICs or semiconductor dies are packaged into a unifying substrate. A SIP may also include multiple independent SOCs coupled together via high-speed communication circuitry and packaged in close proximity, such as on a single motherboard, in a single UE, or in a single CPU device. The proximity of the SoCs facilitates high-speed communications and the sharing of memory and resources.

The term “access point” (AP) may be used herein to refer to a device that allows wireless devices to connect to a wired network using Wi-Fi, or related standards. APs are vital components of wireless local area networks (WLANs) that provide the infrastructure for devices to communicate without the constraints of wired connections. An AP typically connects to a router, switch, or hub via a wired network. The APs may communicate wirelessly with devices using radio frequency signals. APs may vary in features, such as support for multiple radio frequencies, advanced security protocols, and management capabilities. The APs may be used in residential and commercial settings to extend the coverage and capacity of a wireless network.

Over the past several years, the demand for robust and reliable wireless networks in densely populated environments (e.g., urban residential complexes, large office buildings, educational institutions, etc.) has grown significantly. These densely populated environments typically feature numerous APs operating in close proximity to one another. The proximity of these APs may introduce a number of technical challenges, such as signal overlap, channel interference, and network congestion.

In such densely populated environments, the configuration of a single AP may inadvertently impact the performance of nearby APs. For example, an AP may increase interference with neighboring APs simply by changing its own settings to improve its own performance (e.g., by adjusting its channel or signal power, etc.). This interference may degrade the performance of those neighboring APs, prompting them to adjust their configurations in response. This may, in turn, affect other nearby APs, creating a feedback loop in which each AP continuously reoptimizes in reaction to the changes made by other Aps operating in proximity. These dynamic and interdependent optimization processes may lead to overall network instability and inefficiency. Consequently, achieving an optimal configuration may be extremely challenging.

For example, in an urban residential apartment complex with multiple APs deployed within each apartment, in an instance in which one AP changes its channel to reduce interference from a nearby device, the AP initiating its channel change might inadvertently create more interference for an adjacent AP in another apartment. This second AP may switch channels to mitigate the interference, only to affect another nearby AP. This cascading effect may result in a constant state of reconfiguration that prevents the network from stabilizing into an optimal state.

Various embodiments disclosed herein collectively and intelligently configure and optimize multiple Aps operating in proximity to one another to address these challenges and enhance the network's overall performance. The various embodiments disclosed herein may consider the collective impact of configuration changes across all APs to identify configurations that improve overall network quality. For example, some embodiments may use a Monte Carlo-like method to iteratively test different configurations, measure the different configuration's impact on network performance, and probabilistically accept or reject changes based on a calculated tolerance parameter. This approach may reduce the likelihood of creating harmful interference patterns and help the network to converge toward a stable and efficient configuration.

Some embodiments may include a coordinator component and a plurality of AP components. The APs may operate within a dense network environment and support remote management and monitoring capabilities. The APs may provide and apply configuration changes and compute or report quality scores, such as RSSI and throughput. The coordinator, which may be a central server or an elected leader, may be configured to manage multiple APs within a network for comprehensive performance improvements. The coordinator may compute the total quality score based on data from individual APs and determine whether to implement configuration changes, such as by changing configuration parameters for channel selection, channel width, and signal power. Channel selection may have a direct impact on signal quality and interference levels. For example, changing an AP's channel from 1 to 6 may reduce interference by large margins. Adjusting channel width, such as from 20 MHz to 40 MHz, may increase throughput but increase interference levels. Modifying signal power, for example, lowering from 20 dBm to 15 dBm, may reduce interference but decrease coverage.

In some embodiments, the coordinator may be configured to set each AP to an initial state (S0), measure an initial quality score (Q0) for S0 reflecting user experience quality, define and adjust the measurement period to balance speed and accuracy, randomly select an AP from the multiple APs, make a random change to the selected AP's configuration to transition from the initial state (S0) to a new state (S1), measure a new quality score (Q1) for S1 using the defined measurement period, and compare Q1 with Q0. The coordinator may accept the new state (S1) as the basis for further adjustments in instance in which Q1 exceeds Q0. In other instances, in which Q1 does not exceed Q0, the coordinator may apply probabilistic acceptance techniques for suboptimal configurations by determining a probability of acceptance for S1. The coordinator may generate a random number between 0 and 1 and accept S1 in instances in which the random number is less than the determined probability. The coordinator may calculate the probability of acceptance as e^{(Q1-Q0)/T}, where T is a tolerance parameter indicating the system's acceptance of suboptimal states.

In some embodiments, the coordinator may use a Monte Carlo algorithm to randomly select AP configurations. In some embodiments, the coordinator may generate a pseudo-random number, seeded with system time, to decide which AP configuration to change. The coordinator may use probabilistic acceptance with another random number to determine whether to accept a new state. In some embodiments, the coordinator may determine the initial value of the tolerance parameter (T) proportional to the maximum expected change in quality score (Q) and adjust T over time based on the average change in quality per iteration (e.g., starting high and decreasing as improvements diminish). In some embodiments, the coordinator may define an iteration as the duration required to apply a configuration change, measure quality, and decide on acceptance. In some embodiments, the coordinator may define the iterations such that each iteration lasts long enough to measure the quality score accurately, initially 10 minutes and up to 24 hours later. In some embodiments, the coordinator may stop the process when the average change in quality score per iteration approaches zero for several iterations (which may indicate minimal further improvements are available).

The coordinator component may improve network performance and reliability. For example, the coordinator component may improve network performance by improving signal-to-noise ratios, reducing interference, and optimizing or improving throughput across all APs. The coordinator component may improve or optimize channel selection and signal power to achieve more reliable connectivity.

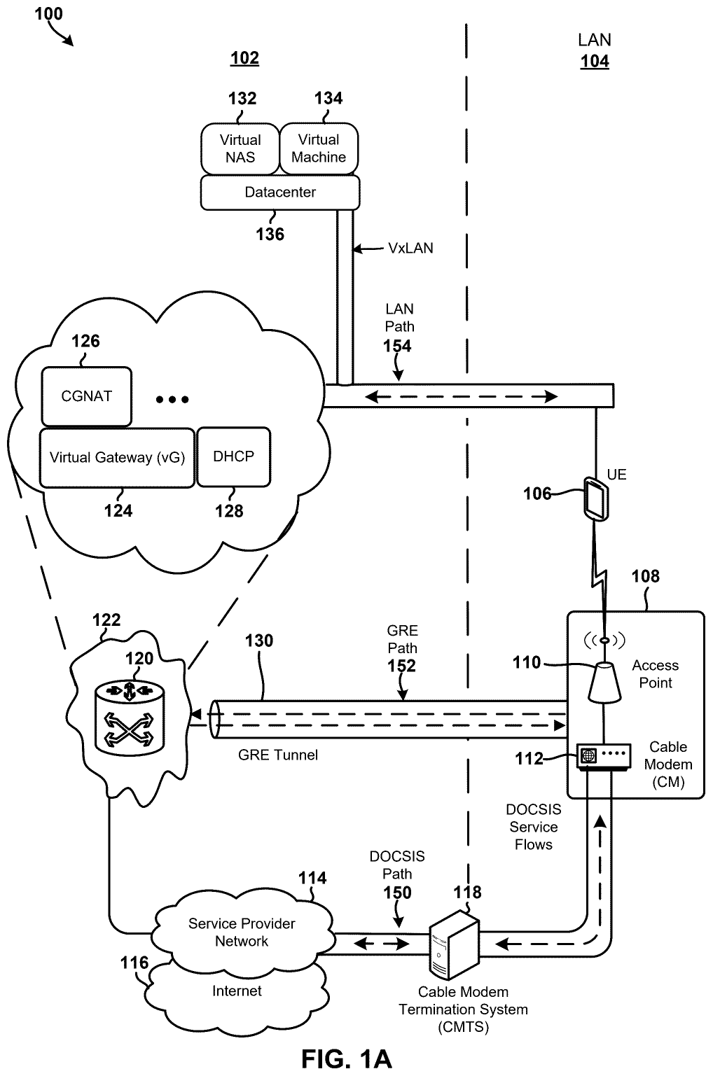

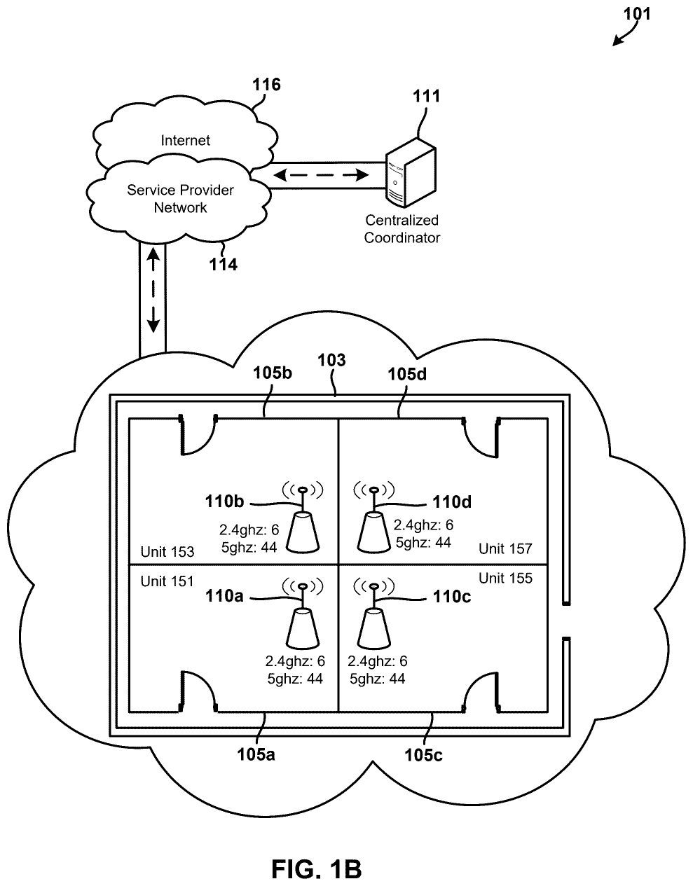

FIG. 1A illustrates a simplified example of a network 100 suitable for implementing various embodiments. In the example illustrated in FIG. 1A, the network configuration includes a wide area network (WAN) 102 and a local area network (LAN) 104. Within the LAN, user equipment (UE) 106 devices connect to customer premise equipment (CPE) 108 via wired and wireless communication links. The CPE 108 includes a wireless access point (AP) 110 and a cable modem (CM) 112 that provide network connectivity to a home or small office network. In various embodiments, the CPE 108 may also include a digital subscriber line (DSL) modem, router, switch, firewall, packet filter, residential gateway, and/or other similar components that allow UE 106 devices on the LAN 104 to connect to the WAN 102 and ultimately the Internet 116. The CPE 108 may include LAN ports (e.g., ports FE0-FE3, etc.) and a LAN interface for communicating with the various UE 106 devices within the LAN 104. The CPE 108 may include a WAN port (e.g., port FE4, etc.) and a WAN interface that allows the UE 106 devices connected to the LAN 104 to communicate with external networks.

The network 100 also includes a cable modem termination system (CMTS) 118 that enhances connections to the service provider network 114 and connects the wireless access point 110 to an access gateway (AG) 120 within the WAN 102. In some embodiments, the access gateway 120 may function independently or may be integrated within a BNG 122 or a virtual gateway (vG) 124, which may be components provided by the service provider to manage network traffic and services. The BNG 122 may include, for example, a carrier-grade network address translation (CGNAT) 126 component, a dynamic host configuration protocol (DHCP) 128 component, and other network management components such as policy and subscriber management systems. Communication within this network 100 may be facilitated or supported by one or more generic routing encapsulation (GRE) tunnels 130, LAN links, Virtual Extensible LAN (VXLAN) links, and other communication pathways. In some embodiments, the network 100 may include a DOCSIS path 150, a GRE path 152, and a LAN path 154.

In some embodiments, the wireless access point 110 may be part of a bridged residential gateway (BRG) that distributes conventional CPE functions such as DHCP, NAT, and firewall between the BRG in the LAN 104 and the BNG 122 or vG 124 in the WAN 102. Unlike traditional architectures that localize DHCP server functionality within the LAN via a CPE modem/router, this configuration deploys the DHCP 128 within the WAN 102, allowing the CPE 108 to primarily facilitate connectivity and enhance UE 106 access to WAN 102 resources.

The BNG 122 may support communications with the CPE 108 via a GRE tunnel 130 and establish a logical subscriber link (LSL) between the wireless access point 110 and the access gateway 120 for seamless service integration and management.

The cable modem (CM) 112 may function as a network bridge that enables bidirectional data communications over radio frequency channels within a hybrid fiber-coaxial (HFC) and/or radio frequency over glass (RFOG) infrastructure. The CMTS 118, typically located within a headend or hubsite, facilitates high-speed communications between the CM 112 and other components of the service provider network 114, providing consumer access to the Internet 116 and IP services over broadband connections.

The CGNAT 126 may translate private-to-private and private-to-public IP addresses, allowing multiple customer networks to share a common public IP address by translating the UE's private IP addresses into public IP addresses.

The DHCP 128 may operate as an independent platform or be hosted by the BNG 122, functioning as a DHCP relay. It dynamically assigns IP addresses to UE 106 devices as part of a lease assignment process and forwards network configuration parameters via the BRG or wireless access point 110. The UE 106 devices may request lease renewals or extensions as needed, and the DHCP 128 may respond by reassigning the same or different IP addresses.

The network may also include components such as a virtual machine 132, virtual network-attached storage (NAS) 134, and a data center 136 that provide commodity hardware and a secure computing infrastructure for hosting BNG 122 or vG 124 components. These components may host specialized services available to customers as an extension of their home LAN 104.

FIG. 1B illustrates an example of a network 101 configuration associated with a multi-dwelling unit (MDU) 103 environment. In the example illustrated in FIG. 1B, the system includes individual units 105a-d (e.g., unit numbers 151, 153, 155, and 157), each equipped with a wireless access point (AP) 110a-d, respectively. The individual units 105a-d may be various types of residential or commercial spaces, such as apartments, condos, dorms, homes, offices, etc. The APs 110a-d may be configured to operate on specific channels to minimize or reduce interference and optimize or improve network performance. In the illustrated example, each AP 110a-d operates on channels 6 for the 2.4 GHz band and 44 for the 5 GHz band.

The network 101 may also include a centralized coordinator 111 component configured to control or manage the APs 110a-d (e.g., for efficient channel utilization, reduced interference, etc.). The centralized coordinator 111 may be communicatively coupled to the MDU 103 environment, individual units 105a-d, and/or APs 110a-d via the service provider network 114 and/or Internet 116.

Each AP 110a-d within the units communicates with the centralized coordinator 111 through the service provider network 114. The APs 110a-d may be strategically placed to ensure optimal coverage and performance within the MDU 103. The centralized coordinator 111 may dynamically adjust the configurations of the APs 110a-d, such as channel selection and power levels, to maintain an efficient and stable network. For example, the centralized coordinator 111 may set each of the APs 110a-d to an initial state (S0), measure an initial quality score (Q0) for the initial state (S0) over a measurement period, define and adjust a measurement period (e.g., to balance speed and accuracy of the results, etc.) and iteratively adjust AP configurations by randomly selecting an AP 110a-d, making a random change to the configuration of the selected AP 110a-d to transition from the initial state (S0) to a new state (S1), and measuring a new quality score (Q1) for the new state (S1) using the defined and adjusted measurement period.

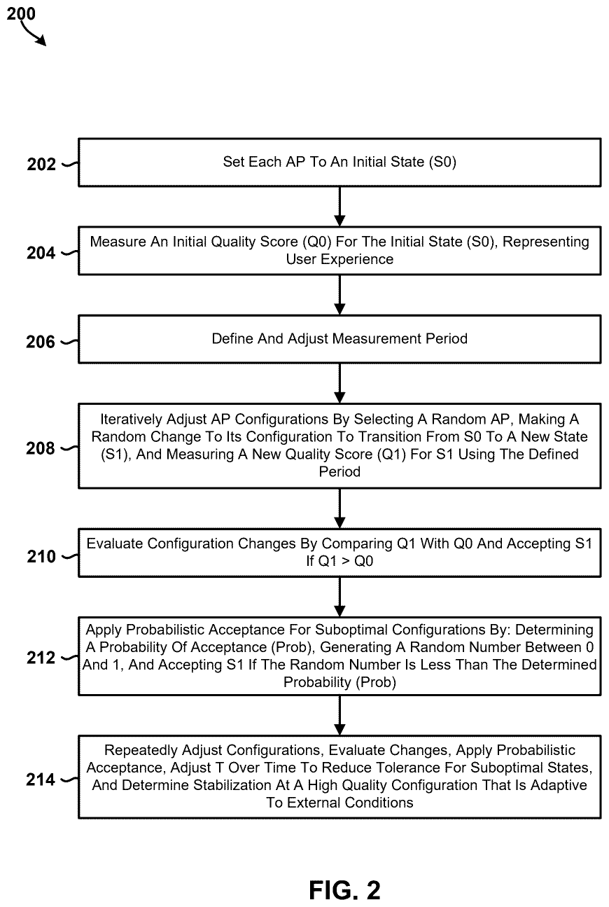

FIG. 2 is a process flow diagram illustrating method 200 of configuring multiple wireless access points (APs) in a dense network computing environment (e.g., MDUs, etc.) in accordance with some embodiments. With reference to FIGS. 1A-2, method 200 may be performed in a computing device by a processing system encompassing one or more components or subsystems discussed in this application (e.g., the centralized coordinator 111, AP 110, etc.). Means for performing the functions of the operations in method 200 may include a processing system including one or more processors and other components described herein. Further, one or more processors of a processing system may be configured with software or firmware to perform some or all of the operations of method 200. To encompass the alternative configurations enabled in various embodiments, the hardware implementing any or all of the method 200 is referred to herein as a “processing system.”

In block 202, the processing system may set each AP to an initial state (S0). For example, the processing system may assign each AP to a predefined channel that reduces or minimizes initial interference, such as using non-overlapping channels 1, 6, and 11 in the 2.4 GHz band. The system may also configure each AP to a uniform signal power level to ensure consistent coverage without causing excessive interference. In addition, the system may apply default configuration parameters (e.g., beacon interval, data rates, security settings, etc.) selected based on best practices and/or the specific requirements of the environment. By setting these initial parameters, the system may establish a standardized baseline configuration that allows a more accurate measurement of the initial quality score (Q0) and provides a reference point for subsequent adjustments and optimizations.

In block 204, the processing system may measure an initial quality score (Q0) for the initial state (S0), representing user experience. For example, the processing system may collect data on various performance metrics (e.g., signal strength (RSSI), signal-to-noise ratio (SNR), throughput, latency, packet loss, user connectivity statistics, etc.) from each AP and connected device. The processor system may then aggregate and analyze the collected data, which may include applying weights to different metrics based on their impact on user experience. For example, latency and packet loss may receive higher weights than RSSI. The system may use a scoring algorithm to normalize the metrics, apply weighted averages, and consider thresholds for acceptable performance levels, ultimately converting the aggregated data into a single quality score (Q0). This score may be used to establish a baseline for evaluating network performance and/or to provide a reference point for assessing the impact of any configuration changes.

In block 206, the processing system may define and adjust a measurement period to balance speed and accuracy. For example, the processing system may initially set a measurement period based on typical network usage patterns and specific environmental requirements. In a densely populated office building, the system may start with a 10-minute measurement period to gather comprehensive data on network performance. If the network remains stable, the system may lengthen the measurement period to 20 minutes, reducing the processing load while ensuring accurate monitoring. Conversely, during peak hours or events when network usage increases significantly, the system may shorten the measurement period to 5 minutes. This adjustment may allow the system to promptly detect and address performance issues such as increased latency or packet loss. By dynamically adjusting the measurement period, the system may balance timely response to network changes and accurate performance data collection. Through these adjustments, the processing system may ensure that it can quickly respond to changing network conditions while collecting accurate and useful performance data for optimizing network performance and enhancing the user experience.

In block 208, the processing system may iteratively adjust AP configurations by selecting a random AP, making a random change to its configuration to transition from S0 to a new state (S1), and measuring a new quality score (Q1) for S1 using the defined period. By iteratively selecting random APs and making random configuration changes, the processing system may comprehensively explore the configuration space and optimize the network for improved performance and user experience.

For example, the processing system may randomly select an AP in a crowded office building and change its operating channel from 6 to 11. This change may transition the AP from its initial state (S0) to a new state (S1). The system may then measure the new quality score (Q1) over the next 10 minutes and evaluate metrics such as signal strength, throughput, and latency. In instances in which the initial quality score (Q0) for the AP was based on a signal strength of −60 dBm, throughput of 50 Mbps, and latency of 20 ms, the new measurements might show an improved signal strength of −55 dBm, throughput of 55 Mbps, and latency of 18 milliseconds (ms). In instances in which Q1 exceeds Q0, the system accepts the new state (S1) as the basis for further adjustments.

Conversely, in a university campus scenario, the system might randomly select an AP in a library and reduce the selected AP signal power from 20 to 15 dBm. After this adjustment, the system may measure Q1 over the next 15 minutes, considering packet loss and user connectivity. The system may accept S1 in instances in which, for example, Q0 indicates a packet loss of 1% and user connectivity of 95%, and Q1 indicates an improved packet loss of 0.5% and user connectivity of 97%.

In block 210, the processing system may evaluate configuration changes by comparing Q1 with Q0 and accepting S1 in response to determining that Q1 exceeds Q0. For example, the processing system may randomly select an AP in a busy office building and change its operating channel from 6 to 11. In instances in which Q0 (Initial State): RSSI=−60 dBm, Throughput=50 Mbps, Latency=20 ms and Q1 (New State): RSSI=−55 dBm, Throughput=55 Mbps, Latency=18 ms, the processing system may determine that Q1 exceeds Q0 due to improved signal strength, higher throughput, and reduced latency. Accordingly, the processing system may accept S1 as the new configuration for the AP.

In block 212, the processing system may apply probabilistic acceptance for suboptimal configurations by determining a probability of acceptance as e^{(Q1-Q0)/T}, generating a random number between 0 and 1, and accepting S1 in instances in which the random number is less than the determined probability. For example, the processing system may randomly select an AP in a busy office building and change its operating channel from 1 to 6. Assuming that the initial quality score (Q0) for this AP, based on throughput and latency, is Q0 (Initial State): Throughput=55 Mbps, Latency=20 ms and that the new quality score (Q1) after the change is: Q1 (New State): Throughput=52 Mbps, Latency=22 ms. Since Q1 is less than Q0, the system may determine the probability of acceptance using a tolerance parameter T set to 5 is Probability: e^{(Q1-Q0)/T}=e^{(52-55)/5}=e^{-0.6}≈0.55. The processing system may also generate a random number such as “0.4.” In this example, the system may accept the suboptimal state S1 because the random number “0.4” is less than the determined probability 0.55.

As another example, the processing system may select an AP in a library and reduce its signal power from 20 dBm to 15 dBm. The initial and new quality scores may be Q0 (Initial State): Packet Loss=0.8%, User Connectivity=97% and Q1 (New State): Packet Loss=1%, User Connectivity=95%. With T set to 3, the probability may be calculated as: Probability: e^{(Q1-Q0)/T}=e^{(-0.02)/3}=e^{-0.0067}≈0.993. If the random number generated is 0.7 (which is less than 0.993) the system may accept S1 despite the higher packet loss and slightly lower user connectivity.

In block 214, the processing system may repeatedly adjust configurations, evaluate changes, apply probabilistic acceptance, adjust T over time to reduce the tolerance for suboptimal states and determine stabilization at a maximum quality configuration that is adaptive to external conditions. For example, the processing system may initially set the tolerance parameter T to a high value (e.g., 10) to allow for broad exploration of configuration changes. The system may select an AP in a crowded office building, change its channel from 6 to 11, and evaluate the resulting quality score (Q1). The system may calculate the probability of acceptance using e^{(Q1-Q0)/T} and compare it with a randomly generated number between 0 and 1 in response to determining that Q1 is lower than the initial quality score (Q0). The processing system may accept the new configuration despite being suboptimal in response to determining that the random number is less than the calculated probability.

As method 200 progresses through the iterations, the processing system may gradually reduce T to make it less likely to accept suboptimal configurations. For example, after several iterations, T may be adjusted to 5, then 3, etc., to fine-tune the configurations and only accept changes that provide clear improvements. The processing system may continue this iterative process, adjusting configurations and evaluating the impacts on performance metrics such as throughput, latency, and user connectivity. The processing system may monitor the changes in quality scores, determine that the network performance has stabilized in response to detecting minimal fluctuations in quality scores, and determine that it has reached a maximum quality configuration in response to determining that the network performance has stabilized. The processing system may maintain these optimal configurations and remain adaptive to external conditions, such as new devices joining the network or changes in interference patterns, by continuing to monitor and make necessary adjustments.

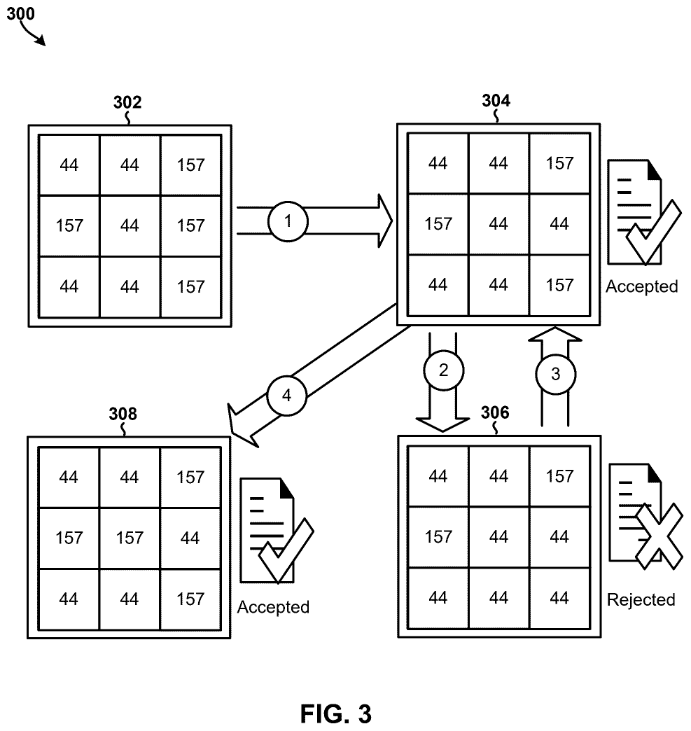

FIG. 3 illustrates an example evaluation of configurations in a simple grid-based system 300. In the example illustrated in FIG. 3, the grid contains cells with values representing quality scores. In particular, FIG. 3 demonstrates how the processing system may evaluate and iterate through various configurations 302-308, accepting those that improve the overall quality score (e.g., 304 and 306) and rejecting those that do not (e.g., 308). The grid-based system 300 illustrates the changes and decisions made during the optimization process. Each step 1-4 involves a configuration change, evaluation of the resulting quality scores, and acceptance or rejection based on the comparison with previous scores. This iterative approach may allow the system to improve towards an optimal configuration incrementally.

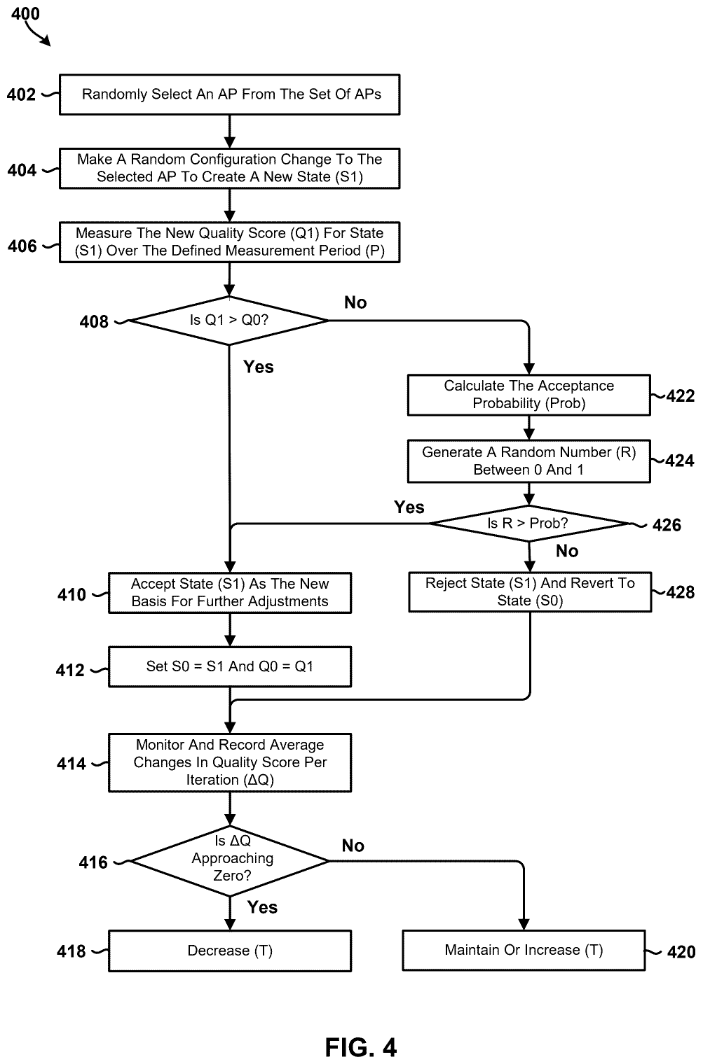

FIG. 4 is a process flow diagram illustrating another method 400 of configuring multiple wireless access points (APs) in a dense network computing environment (e.g., MDUs, etc.) in accordance with some embodiments. With reference to FIGS. 1-4, method 400 may be performed in a computing device by a processing system encompassing one or more components or subsystems discussed in this application. Means for performing the functions of the operations in method 400 may include a processing system including one or more processors and other components described herein. Further, one or more processors of a processing system may be configured with software or firmware to perform some or all of the operations of method 400. To encompass the alternative configurations enabled in various embodiments, the hardware implementing any or all of the method 400 is referred to herein as a “processing system.”

In block 402, the processing system may set the initial state (S0) for each AP, measure the initial quality score (Q0) for the state (S0), define the tolerance parameter (T), set the measurement period (P), and randomly select an AP from the set of APs. For example, the processing system may use a random number generator to select one AP from a list of available APs. This random selection may reduce or prevent bias in the network optimization operations because all APs may have an equal chance of being chosen. These operations may allow the processing system to explore the configuration space of different APs to identify the most effective settings for the network.

In block 404, the processing system may make a random configuration change to the selected AP to create a new state (S1). For example, the processor may randomly change the AP's operating channel from 6 to 11. This random change may introduce variability that allows the system to test different configurations and their impact on network performance. As such, these operations may allow the system to discover new configurations that may improve the quality score.

In block 406, the processing system may measure the new quality score (Q1) for state (S1) over the defined measurement period (P). For example, the processor may collect data on signal strength, throughput, and latency for the selected AP over a 10-minute period. These operations may allow the processing system to evaluate the performance of the new configuration to determine whether it improves the user experience.

In determination block 408, the processing system may determine whether the new quality score (Q1) is greater than the previous quality score (Q0). For example, the processor may compare Q1 (e.g., 55 Mbps throughput, 18 ms latency) with Q0 (e.g., 50 Mbps throughput, 20 ms latency). These operations may allow the processing system to determine whether the new configuration has improved performance.

In response to determining that the new quality score (Q1) is not greater than the initial quality score (Q0) (i.e., determination block 408=“No”), the processing system may calculate the acceptance probability (Prob) as e^{(Q1-Q0)/T} in block 422. For example, the processor may determine the probability as e^{(48-50)/5}≈0.67 in instances in which Q1 is 48 Mbps and Q0 is 50 Mbps with T set to 5. These operations may allow suboptimal states to be accepted based on a probabilistic model (which may help escape local optima, etc.).

In block 424, the processing system may generate a random number (R) between 0 and 1. For example, the processor may use a random number generator to produce a value such as “0.4.” These operations may allow the processing system to introduce randomness in the decision-making process for accepting or rejecting suboptimal states.

In determination block 426, the processing system may determine whether the random number (R) is greater than the acceptance probability (Prob). For example, the processor may compare R (0.4) with Prob (0.67) to determine whether the new state should be accepted despite being suboptimal.

In response to determining that the random number (R) is not greater than the acceptance probability (Prob) (i.e., determination block 426=“No”), the processing system may reject state (S1) and revert to state (S0). For example, the processor may discard the configuration change and restore the AP to its original channel to, for example, maintain the best-known configuration when the new configuration does not offer improvements.

In response to determining that the new quality score (Q1) is greater than the initial quality score (Q0) (i.e., determination block 408=“Yes”) and/or in response to determining that the random number (R) is greater than the acceptance probability (Prob) (i.e., determination block 426=“Yes”), the processing system may accept state (S1) as the new basis for further adjustments in block 410. For example, the processor may accept the new configuration in instances in which Q1 shows improved throughput and latency. These operations allow the processing system to only accept and retain configurations that improve performance or meet probabilistic criteria.

In block 412, the processing system may set the initial state (S0) equal to new state (S1) and set the initial quality score (Q0) equal to the new quality score (Q1). For example, the processor may update its records to reflect that S1 is now the baseline configuration and Q1 is the new baseline quality score. The processing system may perform other similar operations to prepare for the next iteration of configuration adjustments.

In block 414, the processing system may monitor and record average changes in quality score per iteration (ΔQ). For example, the processor may calculate the average improvement in quality score over the last five iterations. These operations may allow the processing system to track the progress of the optimization process.

In determination block 416, the processing system may determine whether the average changes in quality score per iteration (ΔQ) is positive and/or approaching zero. For example, the processor may determine that improvements are diminishing if ΔQ has steadily decreased and is now close to zero.

In response to determining that average changes in quality score per iteration (ΔQ) is approaching zero (i.e., determination block 416=“Yes”), the processing system may decrease the tolerance parameter (T) in block 418. For example, the processor may reduce T from 5 to 3 to make the system more selective in accepting new configurations and focus on fine-tuning.

In response to determining that the average change in quality score per iteration (ΔQ) is positive and/or not approaching zero (i.e., determination block 416=“No”), the processing system may maintain or increase the tolerance parameter (T) in block 420. For example, the processor may keep T at 5 or may increase it to allow for broader exploration of configurations. These operations may allow the processing system to continue exploring new configurations when significant improvements are still being made.

In some embodiments, the processing system may be configured to gradually reduce (T) over time to allow the system to settle into a local or global optimum. In some embodiments, the processing system may be configured to lengthen the measurement period P and continue monitoring to ensure stability. In some embodiments, the processing system may be configured to periodically increase (T) to allow for the exploration of new configurations and adapt to changing environments. For example, the processor may reduce T by 0.5 every 10 iterations or increase T after a set number of iterations without improvement to balance tradeoffs and help ensure that the system adapts to dynamic conditions and finds optimal configurations.

In some embodiments, the processing system may be configured to determine that the system is stable in response to monitoring the average change in quality score per iteration and determining that the average change in quality score per iteration approaches zero.

In some embodiments, the processing system may be configured to iteratively perform method 400 indefinitely to adapt to changes in the external environment. In some embodiments, the processing system may be configured to adjust configurations as needed based on real-time measurements and system behavior.

Some embodiments may include altering specific configuration parameters during the optimization process, such as channel selection, channel width, and signal power. Channel selection may be the most important parameter due to its independent impact on signal quality. For example, changing an AP's channel from 1 to 6 may reduce interference. Adjusting channel width, such as from 20 MHz to 40 MHz, may increase throughput and raise interference levels. Modifying signal power, for example, lowering from 20 dBm to 15 dBm, may reduce interference but may decrease coverage. These parameters may influence network performance by affecting signal quality and interference levels.

In some embodiments, the processing system may be configured to perform the methods 200, 400 using both a network server (e.g., a Coordinator) and APs. The APs may accept and apply configuration changes and compute or provide quality scores. For example, an AP may report metrics such as RSSI and throughput. The Coordinator, which may be a central server or an elected leader, may compute the total quality score based on data from individual APs and decide on configuration changes. The APs may be configured to support remote management and monitoring capabilities.

Some embodiments may include techniques or tools to measure the quality score (Q). The quality of experience may be quantified using a Quality of Service (QOS) Score for each AP, which may be extended to a collection of APs by calculating a normalized product of individual scores. For example, metrics such as SNR, connection drops, goodput, throughput, and latency may be considered. The scores may be normalized and aggregated to reflect overall network performance so that optimization is network-wide and not individual AP-focused.

In some embodiments, the processing system may be configured to use a Monte Carlo algorithm to select AP configurations randomly. The Coordinator Host may generate a pseudo-random number, seeded with system time, to decide which AP configuration to change. For example, the algorithm may list all possible configuration changes and select one based on a random number. Probabilistic acceptance may use another random number to determine if a new state is accepted. This method aids in exploring a broad range of configurations.

Some embodiments may include determining the initial value of the tolerance parameter (T) proportional to the maximum expected change in quality score (Q). For example, if the maximum change in Q is 10, T may start at 10. T may be adjusted over time based on the average change in quality per iteration, typically starting high and decreasing as improvements diminish. For instance, T may be halved when the average improvement per iteration drops. This adjustment may help balance exploration and exploitation during optimization.

In some embodiments, the processing system may be configured to define an iteration as the duration required to apply a configuration change, measure quality, and decide on acceptance. Each iteration may last long enough to measure the quality score accurately, such as 10 minutes initially and up to 24 hours later. Stopping criteria may include when the average change in quality score per iteration (ΔQ) approaches zero. For example, the process may stop if ΔQ is near zero for several iterations (indicating diminishing returns or minimal further improvement).

The embodiments may improve network performance (e.g., better signal-to-noise ratios, reduced interference, optimized throughput across all APs, etc.). Optimizing channel selection and signal power may result in more reliable connectivity.

In some embodiments, the processing system may be configured to overcome technical challenges in optimizing dense networks of APs. For example, optimizing individual APs may lead to interference with neighbors, causing continuous re-optimizations. The embodiments calculate an overall quality score for the AP set and use Monte Carlo methods to explore the configuration space efficiently, avoiding wasted time on poor configurations. Advanced simulation techniques may help proportionally select configurations based on quality changes.

Some embodiments may include that all APs are manageable by a single Coordinator and located in dense environments with potential interference. For example, in an MDU, the Coordinator may manage many APs in an apartment complex, considering each AP's neighbors. This centralized management may be important for effective optimization and comprehensive performance improvements across the network.

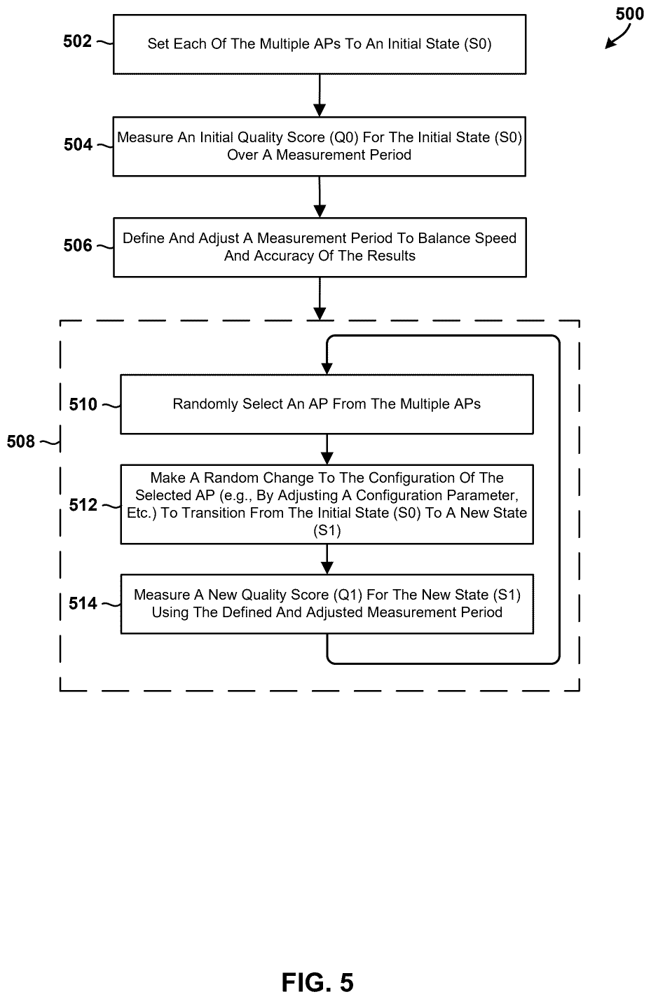

FIG. 5 illustrates a method 500 of configuring (e.g., channels of, etc.) multiple wireless access points (APs) in a dense network computing environment (e.g., MDUs, etc.) in accordance with some embodiments. With reference to FIGS. 1-5, method 500 may be performed in a computing device by a processing system encompassing one or more components or subsystems discussed in this application. Means for performing the functions of the operations in method 500 may include a processing system including one or more processors and other components described herein. Further, one or more processors of a processing system may be configured with software or firmware to perform some or all of the operations of method 500. To encompass the alternative configurations enabled in various embodiments, the hardware implementing any or all of the method 500 is referred to herein as a “processing system.”

In block 502, the processing system may set each of the multiple APs to an initial state (S0). For example, the processing system may configure each AP to a predefined channel, such as channel 6 for the 2.4 GHz band and channel 44 for the 5 GHz band, to minimize initial interference. The system may also set uniform signal power levels across all APs to ensure consistent coverage while avoiding excessive interference. In addition, the processing system may apply default configuration parameters including, but not limited to, antenna configuration, modulation and coding scheme (MCS), channel bonding, frequency band selection, quality of service (QOS) settings, access control settings, network segmentation, and beacon intervals. These initial parameters may establish a standardized baseline configuration for accurately measuring the initial quality score (Q0) and/or serve as a reference point for subsequent adjustments and optimizations.

In block 504, the processing system may measure an initial quality score (Q0) for the initial state (S0) over a measurement period. In some embodiments, the quality score may represent the quality of user experience associated with the wireless network facilitated by the multiple APs. For example, the processing system may collect data on various performance metrics from each AP and connected device. As examples, these metrics may include signal strength (RSSI), signal-to-noise ratio (SNR), throughput, latency, packet loss, and user connectivity statistics. The processing system may aggregate and analyze the collected data, applying weights to different metrics based on their impact on user experience. For example, latency and packet loss may receive higher weights compared to RSSI. The system may use a scoring algorithm to normalize these metrics, apply weighted averages, consider thresholds for acceptable performance levels, etc. to generate a single quality score (Q0) that quantifies a comprehensive assessment of network performance in the initial state.

In some embodiments, the quality score may represent the quality of user experience associated with the wireless network facilitated by the multiple APs. The quality score may indicate how well the network meets user expectations in terms of connectivity, speed, and reliability. The initial quality score may serve as a baseline for evaluating the impact of any configuration changes made during the iterative optimization operations discussed throughout this application.

In block 506, the processing system may define and adjust a measurement period (e.g., to balance speed and accuracy of the results, etc.). For example, the processing system may initially set a measurement period based on typical network usage patterns and specific environmental requirements. The system may start with a shorter measurement period (e.g., 5 to 10 minutes, etc.) to quickly gather initial data on network performance. If the network remains stable and no significant issues are detected, the processing system may gradually lengthen the measurement period to intervals (e.g., 20 minutes, etc.). Conversely, during periods of high network activity or when performance issues are suspected, the system may shorten the measurement period to more frequently assess network conditions.

In block 508, the processing system may iteratively adjust AP configurations, such as by performing the operations in blocks 510-514. For example, in block 510, the processing system may randomly select an AP from the multiple APs. In block 512, the processing system may make a random change to the configuration of the selected AP by adjusting a configuration parameter to transition from the initial state (S0) to a new state (S1). In some embodiments, the processing system may be configured to randomly select the configuration parameter from a collection of configuration parameters associated with the selected AP. In some embodiments, the processor may be configured to make the random change to the selected AP configuration parameter in block 512 to transition from the initial state (S0) to a new state (S1).

In various embodiments, the configuration parameters may include any or all of a channel selection parameter, a channel width parameter, a signal power parameter, a transmission power control parameter, an antenna configuration parameter, a modulation and coding scheme (MCS) parameter, a channel bonding parameter, a frequency band selection parameter, a quality of service (QOS) settings parameter, an access control settings parameter, a network segmentation parameter, a roaming aggressiveness parameter, a dynamic frequency selection (DFS) parameter, an AP load balancing parameter, a beacon interval parameter, a retry limits parameter, a request to send (RTS) and clear to send (CTS) threshold parameter, a fragmentation threshold parameter, or an acknowledgment (ACK) timing parameter.

In block 514, the processing system may measure a new quality score (Q1) for the new state (S1) using the defined and adjusted measurement period. For example, the processing system may collect performance metrics (e.g., RSSI, SNR, throughput, latency, packet loss, etc.) from each AP and connected device in the same manner as for the initial quality score (Q0), aggregate and analyze this data, normalize the metrics, apply the same weights and scoring algorithm used for the initial quality score (Q0), etc. This new score may provide a comprehensive assessment of network performance after the configuration change.

In some embodiments, the processing system may be further configured to evaluate configuration changes by comparing the new quality score (Q1) with the initial quality score (Q0) and accepting the new state (S1) as the new basis for subsequent configuration adjustments in response to determining that the new quality score (Q1) is greater than the initial quality score (Q0).

In some embodiments, the processing system may be further configured to applying probabilistic acceptance for suboptimal configurations by determining a probability of acceptance value for the new state (S1) in response to determining that the new quality score (Q1) is not greater than the initial quality score (Q0), generating a random number between 0 and 1, and accepting the new state (S1) based on whether the random number is less than the determined probability of acceptance value. In some embodiments, determining the probability of acceptance value for the new state (S1) may include setting the probability of acceptance value equal to e(Q1-Q0)/T in which T is a tolerance parameter that is indicative of the system tolerance for accepting suboptimal states.

In some embodiments, the processing system may be further configured to repeatedly adjust the AP configurations, evaluate the configuration changes, apply the probabilistic acceptance for the suboptimal configurations, adjust the tolerance parameter (T) over time to reduce the system tolerance for suboptimal states as the system approaches a threshold value indicating optimal configuration. In some embodiments, the processing system may be further configured to determine whether the average change in quality score per iteration is approaching zero.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the other methods, and vice versa.

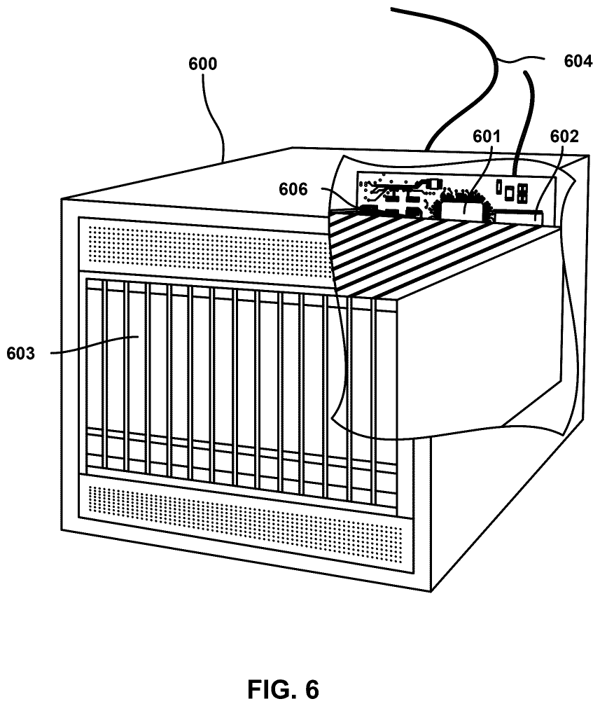

Various embodiments (including, but not limited to, embodiments discussed above with reference to FIGS. 1-5) may be implemented on any of a variety of commercially available computing devices, such as the server computing device 600 illustrated in FIG. 6. Such a server device 600 may include a processor 601 coupled to volatile memory 602 and a large capacity nonvolatile memory, such as a disk drive 603. The server device 600 may also include a floppy disc drive, USB, etc. coupled to the processor 601. The server device 600 may also include network access ports 606 coupled to the processor 601 for establishing data connections with a network connection circuit 604 and a communication network (e.g., IP network) coupled to other communication system network elements.

The processors or processing units discussed in this application may be any programmable microprocessor, microcomputer, or multiple processor chip or chips that can be configured by software instructions (applications) to perform a variety of functions, including the functions of various embodiments described. In some computing devices, multiple processors may be provided, such as one processor within first circuitry dedicated to wireless communication functions and one processor within a second circuitry dedicated to running other applications. Software applications may be stored in the memory before they are accessed and loaded into the processor. The processors may include internal memory sufficient to store the application software instructions.

Implementation examples are described in the following paragraphs. While some of the following implementation examples are described in terms of example methods, further example implementations may include: the example methods discussed in the following paragraphs implemented by a computing device including a processor configured (e.g., with processor-executable instructions) to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1: A method for configuring multiple wireless access points (APs) in a dense network computing environment, the method including setting each of the multiple APs to an initial state (S0), measuring an initial quality score (Q0) for the initial state (S0) over a measurement period, defining and adjusting a measurement period to balance speed and accuracy of the results, and iteratively adjusting AP configurations by randomly selecting an AP from the multiple APs, making a random change to the configuration of the selected AP by adjusting a configuration parameter to transition from the initial state (S0) to a new state (S1), and measuring a new quality score (Q1) for the new state (S1) using the defined and adjusted measurement period.

Example 2: The method of example 1, further including evaluating configuration changes by comparing the new quality score (Q1) with the initial quality score (Q0), and accepting the new state (S1) as the new basis for subsequent configuration adjustments in response to determining that the new quality score (Q1) is greater than the initial quality score (Q0).

Example 3: The method of any of the examples 1 and 2, further including applying probabilistic acceptance for suboptimal configurations by determining a probability of acceptance value for the new state (S1) in response to determining that the new quality score (Q1) is not greater than the initial quality score (Q0), generating a random number between 0 and 1, and accepting the new state (S1) based on whether the random number is less than the determined probability of acceptance value.

Example 4: The method of any of the examples 1-3, in which determining the probability of acceptance value for the new state (S1) includes setting the probability of acceptance value equal to e(Q1â\hat{ }′Q0)/T in which T is a tolerance parameter that is indicative of the system tolerance for accepting suboptimal states.

Example 5: The method of any of the examples 1-4, further including repeatedly adjusting the AP configurations, evaluating the configuration changes, applying the probabilistic acceptance for the suboptimal configurations, and adjusting the tolerance parameter (T) over time to reduce the system tolerance for suboptimal states as the system approaches a threshold value indicating optimal configuration.

Example 6: The method of any of the examples 1-5, further including determining whether the average change in quality score per iteration is approaching zero.

Example 7: The method of any of the examples 1-6, in which the quality score represents the quality of user experience associated with the wireless network facilitated by the multiple APs.

Example 8: The method of any of the examples 1-7, in which the configuration parameters include at least one or more of a channel selection parameter, a channel width parameter, or a signal power parameter.

Example 9: The method of any of the examples 1-8, further including randomly selecting the configuration parameter from a collection of configuration parameters associated with the selected AP.

Example 10: The method of any of the examples 1-9, in which making the random change to the configuration of the selected AP by adjusting the configuration parameter to transition from the initial state (S0) to the new state (S1) includes making a random change to the randomly selected configuration parameter of the selected AP to transition from the initial state (S0) to a new state (S1).

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, components, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, floppy disk, etc. where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for configuring multiple wireless access points (APs) in a dense network computing environment, the method comprising:
setting each of the multiple APs to an initial state (S0);
measuring an initial quality score (Q0) for the initial state (S0) over a measurement period;
defining and adjusting the measurement period to balance speed and accuracy of the results; and
iteratively adjusting AP configurations by:
randomly selecting an AP from the multiple APs;
making a random change to the configuration of the selected AP by adjusting a configuration parameter to transition from the initial state (S0) to a new state (S1); and
measuring a new quality score (Q1) for the new state (S1) using the defined and adjusted measurement period.

2. The method of claim 1, further comprising evaluating configuration changes by:
comparing the new quality score (Q1) with the initial quality score (Q0); and
accepting the new state (S1) as the new basis for subsequent configuration adjustments in response to determining that the new quality score (Q1) is greater than the initial quality score (Q0).

3. The method of claim 2, further comprising applying probabilistic acceptance for suboptimal configurations by:
determining a probability of acceptance value for the new state (S1) in response to determining that the new quality score (Q1) is not greater than the initial quality score (Q0);
generating a random number between 0 and 1; and
accepting the new state (S1) based on whether the random number is less than the determined probability of acceptance value.

4. The method of claim 3, wherein determining the probability of acceptance value for the new state (S1) comprises setting the probability of acceptance value equal to e^{(Q1-Q0)/T} in which T is a tolerance parameter that is indicative of the system tolerance for accepting suboptimal states.

5. The method of claim 4, further comprising repeatedly adjusting the AP configurations, evaluating the configuration changes, applying the probabilistic acceptance for the suboptimal configurations, and adjusting the tolerance parameter (T) over time to reduce the system tolerance for suboptimal states as the system approaches a threshold value indicating optimal configuration.

6. The method of claim 5, further comprising determining whether the average change in quality score per iteration is approaching zero.

7. The method of claim 1, wherein the quality score represents the quality of user experience associated with the wireless network facilitated by the multiple APs.

8. The method of claim 1, wherein the configuration parameters include at least one or more of a channel selection parameter, a channel width parameter, or a signal power parameter.

9. The method of claim 1, further comprising randomly selecting the configuration parameter from a collection of configuration parameters associated with the selected AP.

10. The method of claim 9, wherein making the random change to the configuration of the selected AP by adjusting the configuration parameter to transition from the initial state (S0) to the new state (S1) comprises:
making a random change to the randomly selected configuration parameter of the selected AP to transition from the initial state (S0) to a new state (S1).

11. A centralized coordinator computing system, comprising:
a processor configured to:
set each of multiple wireless access points (APs) in a dense network computing environment to an initial state (S0);
measure an initial quality score (Q0) for the initial state (S0) over a measurement period;
define and adjust the measurement period to balance speed and accuracy of the results; and
iteratively adjust AP configurations by:
randomly selecting an AP from the multiple APs;
making a random change to the configuration of the selected AP by adjusting a configuration parameter to transition from the initial state (S0) to a new state (S1); and
measuring a new quality score (Q1) for the new state (S1) using the defined and adjusted measurement period.

12. The centralized coordinator computing system of claim 11, wherein the processor is configured to evaluate configuration changes by:
comparing the new quality score (Q1) with the initial quality score (Q0); and
accepting the new state (S1) as the new basis for subsequent configuration adjustments in response to determining that the new quality score (Q1) is greater than the initial quality score (Q0).

13. The centralized coordinator computing system of claim 12, wherein the processor is further configured to apply probabilistic acceptance for suboptimal configurations by:
determining a probability of acceptance value for the new state (S1) in response to determining that the new quality score (Q1) is not greater than the initial quality score (Q0);
generating a random number between 0 and 1; and
accepting the new state (S1) based on whether the random number is less than the determined probability of acceptance value.

14. The centralized coordinator computing system of claim 13, wherein the processor is configured to determine the probability of acceptance value for the new state (S1) by setting the probability of acceptance value equal to e^{(Q1-Q0)/T} in which T is a tolerance parameter that is indicative of the system tolerance for accepting suboptimal states.

15. The centralized coordinator computing system of claim 14, wherein the processor is further configured to repeatedly adjust the AP configurations, evaluate the configuration changes, apply the probabilistic acceptance for the suboptimal configurations, and adjust the tolerance parameter (T) over time to reduce the system tolerance for suboptimal states as the system approaches a threshold value indicating optimal configuration.

16. The centralized coordinator computing system of claim 15, wherein the processor is further configured to determine whether the average change in quality score per iteration is approaching zero.

17. The centralized coordinator computing system of claim 11, wherein the quality score represents the quality of user experience associated with the wireless network facilitated by the multiple APs.

18. The centralized coordinator computing system of claim 11, wherein the configuration parameters include at least one or more of a channel selection parameter, a channel width parameter, or a signal power parameter.

19. The centralized coordinator computing system of claim 11, wherein the processor is further configured to randomly select the configuration parameter from a collection of configuration parameters associated with the selected AP.

20. The centralized coordinator computing system of claim 19, wherein the processor is configured to make the random change to the configuration of the selected AP by making the random change to the randomly selected configuration parameter of the selected AP to transition from the initial state (S0) to a new state (S1).

21. A non-transitory computer-readable storage medium having stored thereon processor-executable software instructions configured to cause one or more processors to perform operations for configuring multiple wireless access points (APs) in a dense network computing environment, the operations comprising:
setting each of the multiple APs to an initial state (S0);
measuring an initial quality score (Q0) for the initial state (S0) over a measurement period;
defining and adjusting the measurement period to balance speed and accuracy of the results; and
iteratively adjusting AP configurations by:
randomly selecting an AP from the multiple APs;
making a random change to the configuration of the selected AP by adjusting a configuration parameter to transition from the initial state (S0) to a new state (S1); and
measuring a new quality score (Q1) for the new state (S1) using the defined and adjusted measurement period.

22. The non-transitory computer-readable storage medium of claim 21, wherein the stored processor-executable software instructions are configured to cause a processor to perform operations further comprising evaluating configuration changes by:
comparing the new quality score (Q1) with the initial quality score (Q0); and
accepting the new state (S1) as the new basis for subsequent configuration adjustments in response to determining that the new quality score (Q1) is greater than the initial quality score (Q0).

23. The non-transitory computer-readable storage medium of claim 22, wherein the stored processor-executable software instructions are configured to cause a processor to perform operations further comprising applying probabilistic acceptance for suboptimal configurations by:
determining a probability of acceptance value for the new state (S1) in response to determining that the new quality score (Q1) is not greater than the initial quality score (Q0);
generating a random number between 0 and 1; and
accepting the new state (S1) based on whether the random number is less than the determined probability of acceptance value.

24. The non-transitory computer-readable storage medium of claim 23, wherein the stored processor-executable software instructions are configured to cause a processor to perform operations such that determining the probability of acceptance value for the new state (S1) comprises setting the probability of acceptance value equal to e^{(Q1-Q0)/T} in which T is a tolerance parameter that is indicative of the system tolerance for accepting suboptimal states.

25. The non-transitory computer-readable storage medium of claim 24, wherein the stored processor-executable software instructions are configured to cause a processor to perform operations further comprising repeatedly adjusting the AP configurations, evaluating the configuration changes, applying the probabilistic acceptance for the suboptimal configurations, adjusting the tolerance parameter (T) over time to reduce the system tolerance for suboptimal states as the system approaches a threshold value indicating optimal configuration.

26. The non-transitory computer-readable storage medium of claim 25, wherein the stored processor-executable software instructions are configured to cause a processor to perform operations further comprising determining whether the average change in quality score per iteration is approaching zero.

27. The non-transitory computer-readable storage medium of claim 21, wherein the stored processor-executable software instructions are configured to cause a processor to perform operations such that the quality score represents the quality of user experience associated with the wireless network facilitated by the multiple APs.

28. The non-transitory computer-readable storage medium of claim 21, wherein the stored processor-executable software instructions are configured to cause a processor to perform operations such that the configuration parameters include at least one or more of a channel selection parameter, a channel width parameter, or a signal power parameter.

29. The non-transitory computer-readable storage medium of claim 21 wherein the stored processor-executable software instructions are configured to cause a processor to perform operations further comprising randomly selecting the configuration parameter from a collection of configuration parameters associated with the selected AP.

30. The non-transitory computer-readable storage medium of claim 29, wherein the stored processor-executable software instructions are configured to cause a processor to perform operations such that making the random change to the configuration of the selected AP by adjusting the configuration parameter to transition from the initial state (S0) to the new state (S1) comprises:
making a random change to the randomly selected configuration parameter of the selected AP to transition from the initial state (S0) to a new state (S1).
